(19) United States
(12) Patent Application Publication
(10) Pub. No.: US 2025/0077624 A1
(43) Pub. Date: Mar. 6, 2025

(54) DIRECTED GRAPH GENERATION WITH DIFFUSION KERNELS

(71) Applicant: NVIDIA Corporation, Santa Clara, CA (US)

(72) Inventors: Marc LAW, Toronto (CA); Karsten Julian KREIS, Vancouver (CA); Haggai MARON, Rehvot (IL)

(73) Assignee: NVIDIA Corporation, Santa Clara, CA (US)

(21) Appl. No.: 18/514,847

(22) Filed: Nov. 20, 2023

Related U.S. Application Data
(60) Provisional application No. 63/536,562, filed on Sep. 5, 2023.

(51) Int. Cl. G06F 18/20; G06F 18/214

(52) U.S. Cl. CPC G06F 18/29; G06F 18/2148

(57) ABSTRACT

In various examples, systems and methods are disclosed relating to graph generation. One system includes one or more processing circuits configured to receive a first data structure including one or more relationships between a plurality of components. The one or more processing circuits are further configured to encode, using a predefined function, a second data structure determined based on the first data structure to generate a noisy representation of the second data structure. The one or more processing circuits are further configured to decode, using one or more models, the first data structure based on feature extraction and pattern analysis of the noisy representation.

### CROSS-REFERENCE TO RELATED APPLICATIONS

This application claims priority to U.S. Provisional Application No. 63/536,562, titled Directed Graph generation with Diffusion Kernels, filed Sep. 5, 2023, which is incorporated herein by reference in its entirety and for all purposes.

### BACKGROUND

Graph generation is a technique with broad application, including in fields such as network design and data analysis. Despite the capabilities of various techniques to produce directed graphs, the various techniques often present challenges including inefficiencies stemming from iterative constructions and limitations in scalability and adaptability to certain graphs.

### SUMMARY

Some embodiments relate to a system including one or more processing circuits. The one or more processing circuits are configured to receive a first data structure including one or more relationships between a plurality of components. The one or more processing circuits are further configured to encode, using a predefined function, a second data structure determined based on the first data structure to generate a noisy representation of the second data structure. The one or more processing circuits are further configured to decode, using one or more models, the noisy representation based on feature extraction and pattern analysis of the noisy representation to obtain the first data structure.

In some embodiments, the one or more processing circuits are further configured to update the one or more relationships of the first data structure based on adding or removing at least one of the one or more relationships of the first data structure.

In some embodiments, the first data structure is an adjacency matrix of a directed graph, the plurality of components corresponding to a plurality of nodes of the directed graph, and the one or more relationships correspond to edges in the directed graph.

In some embodiments, the adjacency matrix corresponds to a two-dimensional array including a plurality of cells indicating a presence or an absence of a relationship between at least two of the plurality of components.

In some embodiments, the decoding using the one or more models include using a first model and a second model for the feature extraction and the pattern analysis.

In some embodiments, the first model corresponds to the feature extraction using a decoding of the plurality of components based on one or more inherent features or the one or more relationships of the plurality of components in the noisy representation, and the second model corresponds to the pattern analysis using a decoding of edges based on graph adjacency patterns.

In some embodiments, the system is included in at least one of a control system for an autonomous or semi-autonomous machine, a perception system for an autonomous or semi-autonomous machine, a system implemented using a robot, an aerial system, a medical system, a boating system, a smart area monitoring system, a system for performing deep learning operations, a system for performing simulation operations, a system for generating or presenting virtual reality (VR) content, augmented reality (AR) content, or mixed reality (MR) content, a system for performing digital twin operations, a system implemented using an edge device, a system incorporating one or more virtual machines (VMs), a system for generating synthetic data, a system implemented at least partially in a data center, a system for performing conversational artificial intelligence (AI) operations, a system for performing generative AI operations, a system implementing language models, a system implementing large language models (LLMs), a system for hosting one or more real-time streaming applications, a system for performing light transport simulation, a system for performing collaborative content creation for 3D assets, or a system implemented at least partially using cloud computing resources.

Some embodiments relate to a method, including receiving a first data structure including one or more relationships between a plurality of components. The method further includes encoding, using a predefined function, a second data structure determined based on the first data structure to generate a noisy representation of the second data structure. The method further includes decoding, using one or more models, the noisy representation based on feature extraction and pattern analysis of the noisy representation to obtain the first data structure.

In some embodiments, the method further includes updating the one or more relationships of the first data structure based on adding or removing at least one of the one or more relationships of the first data structure.

In some embodiments, the first data structure is an adjacency matrix of a directed graph, the plurality of components corresponding to a plurality of nodes of the directed graph, and the one or more relationships correspond to edges in the directed graph.

In some embodiments, the adjacency matrix corresponds to a two-dimensional array including a plurality of cells indicating a presence or an absence of a relationship between at least two of the plurality of components.

In some embodiments, the decoding using the one or more models include using a first model and a second model for the feature extraction and the pattern analysis, the first model corresponds to the feature extraction using a decoding of the plurality of components based on one or more inherent features or the one or more relationships of the plurality of components in the noisy representation, and the second model corresponds to the pattern analysis using a decoding of edges based on graph adjacency patterns.

In some embodiments, the first data structure is an asymmetric node representation matrix, the second data structure is a Laplacian matrix, and the plurality of components are a plurality of nodes.

In some embodiments, the predefined function is a deterministic graph diffusion process corresponding to a propagation of node features of the plurality of nodes over a network topology based on the Laplacian matrix and the asymmetric initial node representation matrix.

In some embodiments, the asymmetric node representation matrix is an initial asymmetric node representation matrix prior to receiving the first data structure and is a predicted asymmetric node representation matrix obtained by decoding.

Some embodiments relate to a method, including receiving a plurality of training data structures, wherein each training data structure of the plurality of training data structures includes an adjacency matrix and a Laplacian matrix. The method further includes, for each training data structure of the plurality of training data structures, extracting one or more component representations based on the adjacency matrix and a modified adjacency matrix of each training data structure and updating the one or more component representations to create updated component representations based on exponentiation operations corresponding to the modified adjacency matrix and predefined hyperparameters. The method further includes updating a node decoder based on the updated component representations. The method further includes updating an edge decoder based on the one or more component representations.

In some embodiments, a method further includes adding, for at least one (e.g., each) training data structure, permutation invariance to each training data structure.

In some embodiments, updating the node decoder and the edge decoder corresponds to updating a first neural network and updating a second neural network, and wherein the first neural network is trained for feature extraction based on one or more inherent features or the one or more relationships of the one or more of components representations, and wherein the second neural network is trained for pattern analysis using a decoding of edges based on graph adjacency patterns of the updated component representations.

In some embodiments, a method includes modifying, for at least one (e.g., each) training data structure of the plurality of training data structures prior to the extracting, the adjacency matrix to create the modified adjacency matrix of each training data structure with a disturbance based on a predetermined factor to introduce noisy in the adjacency matrix of each training data structure.

In some embodiments, for each training data structure of the plurality of training data structures prior to the extracting, modifying the adjacency matrix to create the modified adjacency matrix of each training data structure with a disturbance based a random permutation to promote invariance in the adjacency matrix of each training data structure.

Disclosed embodiments can be included in a variety of different systems for network design and data analysis, such as automotive systems having control systems for an autonomous or semi-autonomous machine (e.g., an AI driver, an in-vehicle infotainment system, and so on) and/or a perception system (e.g., sensor systems and so on) for an autonomous or semi-autonomous machine, systems implemented using a robot, aerial systems, medical systems, boating systems, smart area monitoring systems, systems for performing deep learning operations, systems for performing simulation operations, systems for generating or presenting virtual reality (VR) content, augmented reality (AR) content, and/or mixed reality (MR) content, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implementing one or more language models-such as one or more large language models (LLMs), systems for hosting real-time streaming applications, systems for performing light transport simulation, systems for performing collaborative content creation for 3D assets, systems implemented at least partially using cloud computing resources, and/or other types of systems.

### BRIEF DESCRIPTION OF THE DRAWINGS

The present systems and methods for directed graph generation are described in detail below with reference to the attached drawing figures, wherein:

FIG. 1A is an example analysis system, according to one or more embodiments;

FIGS. 1B-1C are example methods of analysis system of FIG. 1A, according to some embodiments;

FIG. 2 is a block diagram illustrating an example computing system suitable for use in the example embodiments described herein;

FIG. 3 is a block diagram depicting an implementation of a graph generation architecture, according to one or more embodiments;

FIG. 4 is an illustrative example of a noise ratio graph, according to one or more embodiments;

FIG. 5 is a block diagram of a flowchart for a method of history reset, according to one or more embodiments;

FIG. 6 is a block diagram of an example data center suitable for use in implementing some embodiments of the present disclosure.

### DETAILED DESCRIPTION

Approaches in accordance with various embodiments can address limitations in existing directed graph generation. In particular, various embodiments can provide improved accuracy and efficiency in generating directed graphs utilizing global topological information. In a system for generating directed graphs using machine learning techniques, the structure and distribution of a given training set of graphs can be analyzed and learned. The system described herein can model new causal systems that reflect the inherent structure and patterns of the training dataset. One category of graph generation is auto-regressive generation. Here, small graph structures are incrementally built upon by continuously adding nodes and edges based on previous structures until a certain criteria, like size, is met. Another strategy of graph generation is one-shot generation. Here, the entire graph, with all its nodes and edges, is generated in a singular action without the incremental buildup. In general, one-shot generation is often more efficient than auto-regressive generation. This is because they bypass multiple intermediate steps, which not only can be computationally taxing but can also lead to accumulative errors. One-shot generation techniques often rely on properties of Laplacian matrices that are satisfied only for undirected graphs. Thus, many one-shot generation techniques are unable to be adapted to digraphs.

To address the inefficiencies with auto-regressive generation and reliance on symmetric scalar products of existing one-shot generation techniques, the system and methods described herein can implement models using singular values and singular vectors. By leveraging these real-value components, which derive from the eigenvalues and eigenvectors, the systems and methods overcome challenges associated with complex number representations in non-symmetric matrices. This approach enhances the graph generation process and ensures consistency in the output. As a result, directed graphs can be efficiently generated, providing an improved machine learning model and improved process for graph creation, particularly in applications that necessitate directed graph structures. This leads to increased applicability in diverse domains (e.g., causality modeling, Markov chains, etc.) broadening the scope of potential use cases.

To generate directed graphs using machine learning techniques, the systems and methods use a denoising autoencoder approach. Unlike traditional autoencoders that derive the noising process from a neural network, the systems and methods described herein can apply closed-form expressions based on a heat expression. This expression translates the global topological information of a graph into node features, allowing for the creation of directed graphs that closely match the distribution of the training dataset. Accordingly, the present disclosure relates to systems, methods, and non-transitory computer-readable media for improving graph generation of directed graphs. The system combines Laplacian dynamics, diffusion processes, and heat expressions to develop a new and improved approach to handling digraphs. This approach addresses limitations observed in traditional methods and offers both scalability and efficiency.

By leveraging the unique properties of Laplacian matrices, the system can generate graphs that mirror the structures of the training graphs. For example, during protein synthesis, proteins can often be depicted as graphs where different components of a protein form nodes and their interactions manifest as edges. However, not all proteins can be suitably represented as graphs. One solution is to train a model to understand and generate new graphs. In particular, in the protein scenario, the model can aim to produce new proteins that reflect the graph distribution used during its training phase. Conventionally, models have been trained on undirected graphs, essentially a collection of nodes linked by edges without any directionality. The systems and methods described herein change that approach by being directed to producing graphs where edges have clear directions. Specifically, the model can generate all nodes and their connecting edges in a single action, a method known as the one-shot generative model (OSGM).

For undirected graphs, representation is generally performed using a symmetric adjacency matrix. This can lead to the formation of the graph's Laplacian matrix, which also maintains symmetry. The Laplacian matrix provides information about the graph in the form of its eigenvectors and eigenvalues. A significant amount of the graph's data is embedded in a subset of these eigenvectors and eigenvalues. A technical problem with standard systems is their limitation to undirected graphs. That is, in instances where the Laplacian matrix is symmetric, all its eigenvalues and eigenvectors have real values. But, with non-symmetric Laplacian matrices, these eigenvalues and eigenvectors can manifest as complex numbers. Using complex values in modeling poses inherent challenges. Moreover, undirected graphs are inadequate for situations demanding an order to the edges, like tree graphs which necessitate a directed format. Given these limitations, the systems and methods in this disclosure reorient the computation approach from eigenvalues and eigenvectors to singular values and singular vectors, which are inherently real values, to generate directed graphs. Such directed graphs are utilized especially when there's an element of causality, like in causal relationships. Consequently, these systems and methods can provide improvements in implementations requiring a causal mapping or where directed graphs are a prerequisite, such as in Markov chains, spatiotemporal events, or other applications requiring directed graph structures.

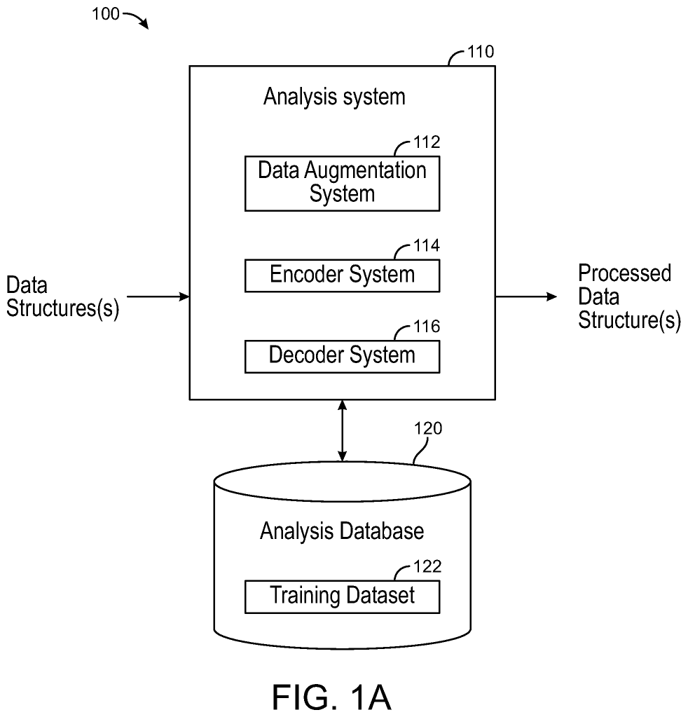

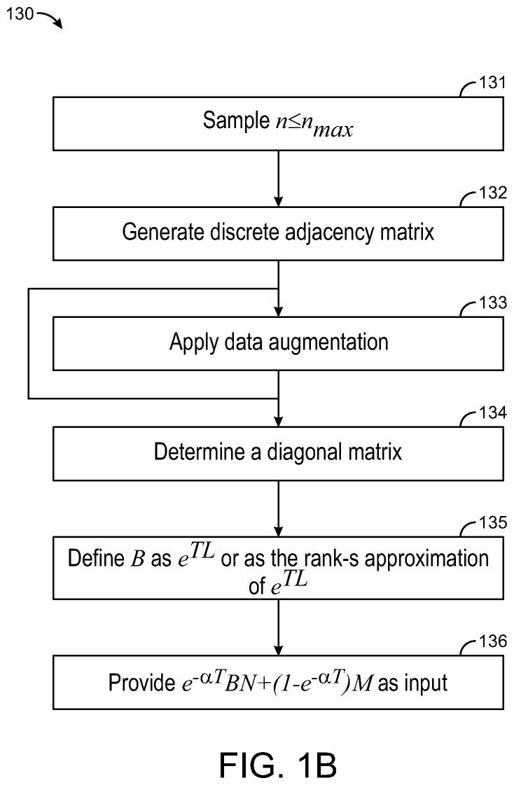

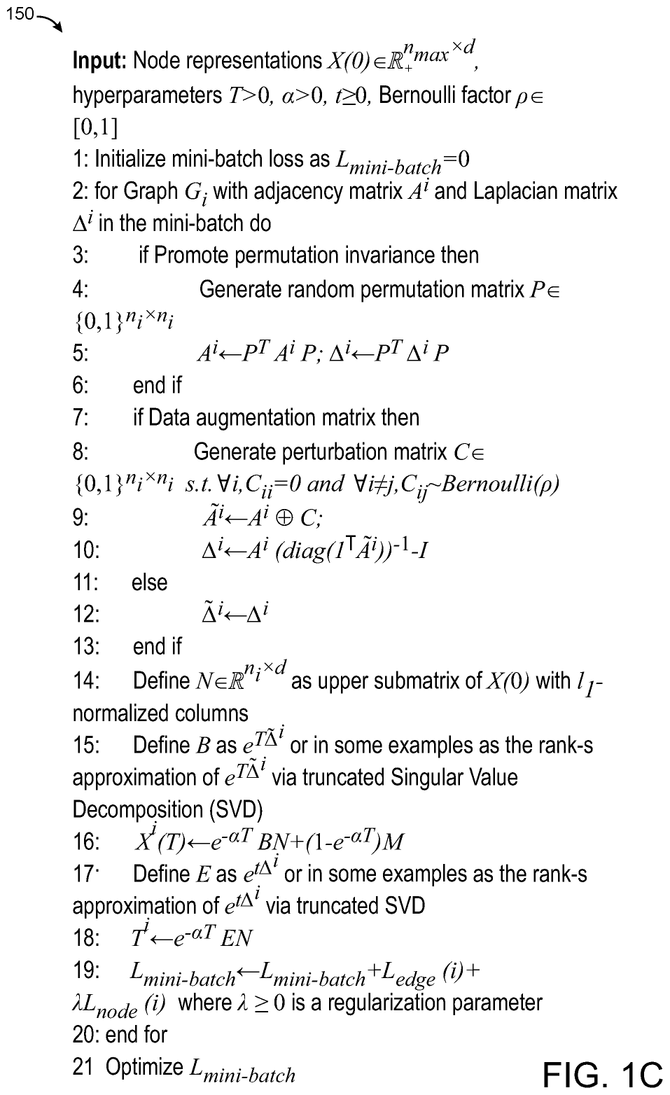

Referring now to FIG. 1A, an illustration of components of an example analysis system 110 that can be utilized in accordance with various embodiments. The computing environment 100 is shown to include the analysis system 110 and analysis database 120.

The analysis system 110 may include one or more systems (e.g., computer-readable instructions executable by a processor) and/or circuits (e.g., ASICs, Processor Memory combinations, logic circuits, etc.) configured to perform various functions of the analysis system 110. In some arrangements, the analysis system 110 may be or include a data augmentation system 112, an encoder system 114, and a decoder system 116. It should be understood that various implementations may include more, fewer, or different systems than those illustrated in FIG. 1A, and all such modifications are contemplated to be within the scope of the present disclosure. In general, the analysis system 110 is configured to generate directed graphs in a single step. It consists of several components—the data augmentation system 112, the encoder system 114, and the decoder system 116—each of which contributes to the efficient and accurate generation of directed graphs that reflect the inherent structure and patterns of a training dataset 122.

In general, the analysis system 110 can be configured to receive and/or generate a first data structure (e.g., containing data of an initial adjacency matrix) including one or more relationships between one or more components (e.g., edges between nodes). The encoder system 114 can encode (e.g., using a predefined function, such as a deterministic noising process) a second data structure (e.g., determined from the adjacency matrix, such as a Laplacian matrix) to generate a noisy representation of the second data structure. In some embodiments, prior to encoding, the data augmentation system 112 can update the one or more relationships of the first data structure based on adding or removing at least one or more relationships of the first data structure (e.g., adjacency matrix). The decoder system 116 can decode (e.g., using one or more models, such as neural networks) the first data structure (e.g., containing data of a predicted adjacency matrix) predicted based on feature extraction and pattern analysis of the noisy representation.

In some embodiments, the analysis system 110 can perform the operations corresponding to the test time/in application method (or algorithm) defined as Method 130 of FIG. 1B. In general, method 130 can include an input: node representations X(0)∈ [symbol] ₊ⁿ^{ₘₐₓ}^{×d}, hyperparameters T>0, α>0, t≥0, Bernoulli factor ρ∈[0, 1]. At block 131, the analysis system 110 can sample n≤nₘₐₓ, defining N∈ [symbol] ^{n×d} as upper submatrix of X(0) with [symbol] ₁-normalized columns. At block 132, the analysis system 110 can generate discrete adjacency matrix A∈{0, 1}^{n×n} such that ∀i≠j, Aᵢⱼ˜Bernoulli(μ), and ∀i, Aᵢᵢ=1. At block 133, in some examples, the analysis system 110 can apply data augmentation to obtain perturbed matrix Ã (e.g., Ã=A⊕C s.t. ∀i≠j, Cᵢⱼ˜Bernoulli(p)). At block 134, the analysis system 110 can determine the diagonal matrix D∈ [symbol] ₊^{n×n} such that Dᵢᵢ=ΣⱼÃⱼᵢ. Define L:=ÃD⁻¹−I. At block 135, the analysis system 110 can define B as e^{TL} or optionally as the rank-s approximation of e^{TL} via truncated singular value decomposition (SVD). At block 136, the analysis system 110 can provide matrix as e^{-αT} BN+(1−e^{-αT})M as input of the decoder system 116 of analysis system 110 that returns an adjacency matrix.

The test time algorithm (Method 130) is directed to the generation of a directed graph (i.e., a new graph). The analysis system 110 can be configured to sample a select subset of node representations. This process can narrow down the dataset for efficient processing. Once sampled, the analysis system 110 can defines an upper submatrix, labeled N, which is designed to have [symbol] ₁-normalized columns. This normalization ensures that the magnitude of vectors in the matrix remains consistent. Additionally, to facilitate graph-based analysis, the analysis system 110 can generate an adjacency matrix. In particular, the adjacency matrix can have values ranging between 0 and 1.

The data augmentation system 112 can be configured to introduce perturbation to the existing adjacency matrix. By either adding or removing binary values (0 or 1) from the matrix, the data augmentation system 112 creates a perturbed version of the matrix, referred to as Ã. In some embodiments, data augmentation may not be performed. For example, when the training dataset 122 may be limited in size, data augmentation can be introduced. In another example, if the training dataset 122 is diverse, introducing perturbations via data augmentation cannot be beneficial and can cause unnecessary noise.

Referring to the data augmentation system 112 in greater detail. In some embodiments, a method of augmenting data within a graph involves using an adjacency matrix, A. This binary matrix, populated with values of 0 or 1, can be adjusted based on certain probability distributions or specific values, such as a particular row. The process can include the data augmentation system 112 adding or removing edges. This can be achieved using another matrix, C, which serves as a corruption matrix. This matrix, when applied using the XNOR operation on the adjacency matrix, can introduce significant changes (i.e., where both the elements of A and C are binary). In some embodiments, another method can include adding random noise to the matrix, which can be based on a Bernoulli distribution.

The encoder system 114 can be configured to generate a Laplacian matrix. In some embodiments, the Laplacian matrix is defined as matrix D (e.g., in-degree diagonal), where the Laplacian matrix is defined as S:=AD⁻¹−I, and where S is column stochastic (i.e., ∀i, ΣⱼAⱼᵢ), and I is the identity matrix, e.g., random walk Laplacian. Additionally, the encoder system 114 can define matrix, B, as the exponential matrix of e^{TL} or in some examples as the rank-s approximation (but not required) (e.g., using a low-rank approximation of the kernel matrix by using a truncated SVD). In some embodiments, the encoder system 114 can generate a noisy representation X(T), then the decoder system 116 can attempt to predict whether there is an edge between any pair of nodes.

Referring to the encoder system 114 in greater detail, in one or more embodiments, the encoder system 114 implements a diffusion process that generalizes a class of exponential kernels over discrete structures, referred to herein as diffusion kernels (sometimes referred to as heat kernels). In particular, the diffusion kernel expresses the notion of a discrete local neighborhood of nodes in terms of a global similarity function over the whole set of nodes of an undirected and directed graph. In some embodiments, a directed graph G=(V, E) can be defined by its set of n nodes V={vᵢ}ᵢ₌₁ⁿ and its set of edges E. Its adjacency matrix A∈ [symbol] ₊^{n×n} can satisfy Aᵢⱼ=1 if (vᵢ,vⱼ)∈E and Aᵢⱼ=0 otherwise. In some embodiments, although in some examples, the encoder system 114 can add self-loops by constraining A to satisfy ∀i, Aᵢᵢ=1. An in-degree diagonal matrix D∈ [symbol] ₊^{n×n} can be defined so that Dᵢᵢ=ΣⱼAⱼᵢ. Matrix S can be a column stochastic defined as S:=AD⁻¹ (i.e., ∀i, ΣⱼAⱼᵢ=1). Additionally, an identity matrix can be denoted as I, the all-ones vector by 1, and given some matrix N:=X(0)∈ [symbol] ^{n×d} where the i-th row of N is the initial d-dimensional feature representation of vᵢ (i.e., X(t), where t=0).

With regards to Laplacian dynamic, the encoder system 114 can define the negative of the random walk Laplacian matrix as L:=S−1=AD⁻¹−I. L can be viewed as a matrix form of the discrete Laplace operator which approximates the continuous Laplace operator (e.g., Laplace-Beltrami) in differential geometry. Given a twice-differentiable real-valued function ƒ defined on some manifold, the Laplace operator can be defined as the divergence of the gradient grad ƒ and provides us with an estimate of how far apart ƒ maps nearby points. Since L is not symmetric, the encoder system 114 can use both L or L^{T} as the different left and right eigenvectors. Thus, Δ can be denoted as Δ∈{L, L^{T}}. During heat diffusion, Δ=L can be focused on. It should be understood that heat diffusion is not a machine learning diffusion model. In some embodiments, when Δ=L^{T} can be solved using a consensus model (e.g., when Δ=L^{T}, ensures matrices are row stochastic, making it suitable for contexts where each row of X(0) represents a distinct node category). With regard to heat diffusion, a heat source term Q(t)∈ [symbol] ^{n×d} that generates noise over time t≥0 can be defined. If ∀t≥0, Q(t)=0, then Q is called homogenous. It is called homogenous otherwise. The nonhomogeneous heat expression can be defined as (Expression 1):

$$∀ t \geq 0 ,$$

$$\frac{d}{d t} X ( t ) = Δ X ( t ) + Q ( t ) where$$

$$X ( t ) is the representation of nodes at time t$$

Z(t) can be defined as Z(t):=e^{tΔ}X(0) and F(t):=∫₀^{t}e^{(t-s)Δ}Q(d)ds where e^{tΔ} is the matrix exponential of the matrix tΔ. The matrix exponential can be a generalization of the standard exponential function to square matrices and is often used to solve systems of linear differential equations. Thus, for any formulate Q, Expression 1 can be solved by the following expression when A is constant over time (Expression 2):

$$∀ t \geq 0 , X ( t ) = {e}^{t Δ} X ( 0 ) + {\int }_{0}^{t} {e}^{( t - s ) Δ} Q ( s ) d s = Z ( t ) + F ( t )$$

In Expression 2, if Q is homogenous, then ∀t≥0, F(t)=0 and Expression 2 can reduce to ∀t≥0, X(t)=Z(t). It should be understood that a difference between other diffusion processes is the use of global topological information of the graph via e^{tΔ} over time t. Thus, the noise is introduced by the encoder system 114 via the term F(t). Here, the goal can be to define a noising process that maps the input X(0) to an informative representation close enough to some analytically tractable distribution from which can be sampled at test time. To this end, the encoder system 114 can construct a noisy representation X(T) where T>0 is an arbitrary constant, and is defined such that X(T) is similar to some matrix with all its elements equal to the same value. This matrix can be defined as M. Then, one or more denoising decoders (i.e., decoder system 116) can be trained to predict the nodes and/or edges when given some X(T) as input.

With regard to the formulation of the heat source term Q. Q can be formulated so that X(T) tends to M as T→+∞. To this end, the encoder system 114 can add the constraint N=X(0), which is column stochastic, and the column stochastics uniform noise matrix can be defined as

$$M := \frac{1}{n} 1 {1}^{T} ∈ {\{ \frac{1}{n} \}}^{n \times d} .$$

The matrix e^{tΔ} is column stochastic for all t≥0, which implies Z(t)=e^{tΔ}N is column stochastic for all t≥0. To simplify the formulation of Q, the encoder system 114 can define some matrix R:=e^{-TΔ}M for some arbitrary T>0. Thus, the formulation of Q and F can be defined as a proposition (Expression 3):

$$Q ( s ) := α {e}^{- α s} {e}^{s Δ} ( R - {e}^{βΔ} X ( 0 ) ) ⇒ F ( t ) = ( 1 - {e}^{- α s} ) {e}^{t Δ} ( R - {e}^{β Δ} X ( 0 ) )$$

where α>0 is a noisy diffusivity rate hyperparameter, and β≥0 is another hyperparameter that can be tuned to control the Laplacian dynamics further.

With the proposition above (Expression 3), X(t) can be written only as a function of X(0) and Δ in Expression 2 (shown below as Expression 4):

$$X ( t ) = {e}^{t Δ} ( X ( 0 ) + ( {e}^{- α t} - 1 ) {e}^{β Δ} X ( 0 ) + ( 1 - {e}^{- α t} ) R )$$

In some embodiments, if β=0, a simpler formulation can be defined of Expression 4 (shown below as Expression 5):

$$β = 0 ⇒ {e}^{β Δ} = I ⇒ X ( t ) = {e}^{- α t} Z ( t ) + ( 1 - {e}^{- α t} ) {e}^{t Δ} R$$

In this case, X(T)=e^{-αt}Z(t)+ (1−e^{-αt})M is column stochastic. In the following, the encoder system 114 can assume β=0, but the approach can be generalized to any β≥0. If Δ is given, X(t) can be defined as a function of X(t+τ) for all time step τ≥0 (Expression 6):

$$β = 0 ⇒ X ( t ) = {e}^{α τ} {e}^{- τ Δ} X ( t + τ ) + ( 1 - {e}^{α τ} ) {e}^{t Δ} R$$

Accordingly, Expression 6 corresponds to the reverse process that removes noise in the denoising models. However, it can be assumed that the denoising decoders (e.g., edge and node decoder neural networks) that are trained do not have access to Δ when graphs are sampled at inference time, so the denoising decoders would also have to predict Δ. Accordingly, the decoder system 116 can be trained to build an efficient generative model for the following reasons. First, the noisy representation X(t) has a closed-form formulate for all τ≥0 (see Expression 4) that depends only on X(0) and A. This allows the decoder system 116 to calculate X(t) without adding noise iteratively, Second, the denoiser representation Z(t) can be defined in closed-form when given only X(0) or X(t). During training of the node and edge decoder neural network, arbitrary time T>0 can be set to construct a noisy representation X(T)=Z(T)+F(T) that is given as input of a denoising decoder whose goal is to predict the denoised representations Z(t)=e^{tΔ}X(0) with some arbitrary t∈[0, T] depending on the context. Further to above, the denoising decoder predicts Z(t) without being provided A at test time. Lastly, the limit distribution

$${lim}_{T \to ∞} X ( T ) = M$$

does not depend on X(0). In particular, all the elements of X(T) are in the interval

$$[ \frac{( 1 - exp ( - α T ) )}{n} , \frac{( 1 + ( n - 1 ) exp ( - α T ) )}{n} ] .$$

A value of T and a can be selected so that sufficient information of the graph is preserved in X(T), and denoised clean edges can be recovered from it.

In some embodiments, the main difference between T>0 and α>0 is that T acts as a multiplicative factor on the eigenvalues inside the exponential, whereas α>0 only has an impact on the real part λᵣ. Specifically, the heat diffusion is towards a distribution that can be approximated by an analytic distribution (e.g., sample from a symmetric Dirichlet distribution with high concentration parameter) while preserving sufficient information about X(0) to perform denoising. Moreover, X(t) is column stochastic when t=0 and t≥T, but X(t) can contain some negative elements when t∈(0, T) due to the formulation of R. This is often not a problem since the goal is to reconstruct Z(t) which is column stochastic for all t≥0.

Accordingly, the heat kernel or diffusion kernel is an extension of heat kernels to non-symmetric matrices, without needing the concept of Reproducing Kernel Banach Spaces (RKBS). For a function to be a kernel function, it must satisfy specific conditions; the function K in this context is usually symmetric with a real set of coefficients. When considering non-symmetric functions, the kernel matrix is column stochastic, and if all coefficients are nonnegative, certain conditions are met. Despite not requiring RKBS, the encoder system 114 implementation aligns with the proposition that any nontrivial function K on a finite set X is the reproducing kernel of some RKBS on X. Thus, the encoder system 114 provides a method that extends traditional heat kernels to non-symmetric matrices, enabling more flexible representations without the need for the complex concept of RKBS.

Thus, the encoder or noising process is given an initial node representation matrix N=X(0) and a Laplacian matrix −A to generate in closed form some noisy representation X(T) at some arbitrary time T>0. It should be understood that this type of graph diffusion, implemented by encoder system 114, is not learned and does not require a neural network. However, in some embodiments, the decoder system 116 can be implemented as a multi-task learning formulation for the decoder part of the denoising autoencoder. It can be assumed that the decoder system 116 is not provided Δ at test time, so it will not be able to directly apply the reverse process in Expression 6. Instead, the decoder system 116 can learn a neural network (referred to herein as the node decoder) that predicts the denoised node representation matrix Z(t) where t∈[0, T] (and Z(0)=X(0)). Another neural network (referred to herein as the edge decoder) is jointly learned to predict the adjacency matrix A.

Referring now to the decoder system 116 generally. The decoder system 116 can be configured to train (updated) a plurality of neural networks and during test time (or in application) output reconstructed node representations and adjacency matrices of graphs based on a given noisy input from encoder system 114. In particular, with regard to training, the decoder system 116 can be configured to perform model training using training graphs stored in training dataset 122 of analysis database 120 to generate one or more neural networks (e.g., node decoder neural network and edge decoder neural network). The objective of model training is to generate directed graphs G that closely mirror the structure and inherent patterns found within the training graphs of training dataset 122. Training graphs can be depicted as Gᵢ=(Vᵢ, Eᵢ), and to achieve the objective, each Gᵢ can be represented by its adjacency matrix Aⁱ∈{0, 1}ⁿ^{ᵢ}^{×n}^{ᵢ} and its Laplacian matrix −Δⁱ where nᵢ:=|Vⁱ| can be the number of nodes. Accordingly, the decoder system 116 can assume, for each Gᵢ, the decoder system 116 is provided (e.g., from the training dataset 122) with a column stochastic matrix N:=Xⁱ(0)∈[0, 1]ⁿ^{ᵢ}^{×d}, where d>0 is an arbitrary hyperparameter and the N can be learned by decoder system 116, for implementation in decoder system 116. During training, for two different graphs Gᵢ and Gⱼ of the same size nᵢ=nⱼ are given the same matrix N=Xⁱ(0)=X^{j}(0). In some embodiments, if nᵢ>nⱼ then X^{j}(0) is the [symbol] ₁-normalized upper submatrix of X^{j}(0), which corresponds to applying a mask and renormalizing. In some embodiments, the values of T and α can be defined such that it is greater than 0 and the noise ratio defined as 1−e^{-αT} is close to 1. The decoder system 116 can then construct the matrix Xⁱ(T)=e^{-αT}e^{TΔ}^{ⁱ}N+(1−e^{-αT}) that can be provided as input into a node decoder (φ) and an edge decoder (ψ) (both neural networks) during training (sometimes referred to herein as updating).

In some embodiments, during training (or updating), the node decoder (φ) (i.e., a first neural network) of decoder system 116 can receive matrix Xⁱ(T). In general, the node decoder can be parameterized as a Set Transformer, followed by a multilayer perceptron (MLP) with ReLU activation function and trained so that the output, φ(Xⁱ(T)) is similar to some target matrix Tⁱ that does not contain noise. For example, formula Tⁱ=Zⁱ(1)=e^{Δ}^{ⁱ}N can be used to derive the specific matrix representations, such as target matrix T′ derived from the graph's Laplacian matrix Δⁱ and another matrix N. In some embodiments, to provide a high degree of similarity between the output and the target matrix, a minimization strategy can be employed, defined as loss function, L_{node}(i):=∥φ(Xⁱ(T))−Tⁱ∥_{F}², where the 2 denotes the difference between the matrices is squared and the F denotes the Frobenius norm, which is a measure of matrix magnitude (i.e., the square root of the sum of the absolute squares of its elements, and by squaring the norm, the node decoder obtains a sum of squared errors). Thus, the loss function quantifies the difference between the output of the node decoder during training, φ(Xⁱ(T)), and the target matrix, Tⁱ, that does not contain noise.

In some embodiments, during training, the edge decoder (ψ) (i.e., a second neural network) of decoder system 116 can receive matrix Xⁱ(T) and produce an output. The p-th row of ψ(Xⁱ(T) by (ψ(Xⁱ(T)))ₚ, where (ψ(Xⁱ(T)))ₚ refers to the p-th row of the output of the edge decoder when it process the matrix Xⁱ(T) during training. In general, the edge decoder predicts or estimates whether or not there exists an edge between pairs of nodes. This can be formulated as L_{edge}(i):=Σ_{p≠q}H(ψ([ψ(Xⁱ(T))ₚ, ψ(Xⁱ(T))_{q}]),A_{pq}ⁱ) where [ [symbol] ] denotes concatenation, and w is a learned MLP, and H is cross-entropy loss. Thus, the final loss can be minimized as (Expression 7):

$$\sum {L}_{edge} ( i ) + λ {L}_{node} ( i ) where λ \geq 0 is a regularization parameter$$

Accordingly, during the training phase, the node and edge decoders of decoder system 116 are exposed to multiple training graphs from the training dataset 122 of analysis database 120. These training graphs serve as a benchmark for the decoders to understand the underlying patterns and structures inherent to the type of graphs the model is expected to handle post-training. As the training progresses, the decoder system 116 continually refines its parameters based on the feedback it receives from the defined loss functions. In some embodiments, the objective is to reduce the difference between the predicted outputs and the actual target values. Thus, by leveraging a combination of matrix representations, concatenations, MLPs, and specified loss functions, the decoder system 116 can maintain performance on new data, providing reliable graph generation or predictions in deployment.

Furthermore, a training algorithm can be implemented incorporating the final loss of the edge decoder and node decoder described above. The training algorithm can generally be defined as shown in FIG. 1C (Method 150).

As shown, the training Method 150 is designed to refine and optimize the model's ability to generate and predict graph structures. In some embodiments, the Method 150 begins by accepting several initial inputs. Among these are the node representations, which serve as starting points to describe individual nodes in the graph. The hyperparameters also guide the training process: T represents an arbitrary constant, a is a scaling factor, t is a time parameter, and the Bernoulli factor ρ defines the probability threshold for certain operations. These parameters set the thresholds for the training, defining how aggressively the model should adjust its learning.

In some embodiments, during initialization the mini-batch loss can be set to zero at the start. This loss accumulates errors from individual graph samples in a mini-batch and provides a collective measure of how well the model is predicting. Resetting it for each batch ensures that only the errors from the current batch are considered. In some embodiments, during the processing of each graph in the mini-batch, decoder system 116 executing Method 150, performs several steps. In response to permutation invariance being promoted, random permutation matrices are generated to shuffle the order of the nodes in the graph. In some embodiments, data augmentation can be performed, where the adjacency matrix of the graph can be slightly altered using a perturbation matrix. This alteration creates variations of the same graph, which can improve the model's adaptability. The decoder system 116, implementing Method 150, checks if data augmentation is desired or needed; if not, the original Laplacian matrix is retained. In some embodiments, several matrices can then be defined to aid in the training process. The N matrix is generated or defined by taking a segment of the initial node representation matrix and normalizing its columns. Following this, the B matrix is determined through exponential transformations of the Laplacian matrix, capturing the inherent graph structures. These transformations can be approximated using techniques like Singular Value Decomposition (SVD) to make computations more manageable. The X(T) matrix is then calculated using a combination of the previously defined matrices. Another matrix, E, similar to B but with a different transformation, can also be defined. In some embodiment, after all the matrices are in place, the decoder system 116 can proceed to compute how well the model is doing. It does this by calculating the mini-batch loss, which aggregates errors from both node and edge decoders (described above with reference to L_{edge} and L_{node}). Thus, the loss quantifies the difference between what the model predicts and the actual training data. A regularization parameter can also be introduced to prevent overfitting by penalizing overly complex models. Lastly, after all the individual graph errors are accumulated into the mini-batch loss, optimization techniques can be employed to adjust the model's parameters.

Accordingly, the L_{edge}, L_{node}, and L_{mini-batch} losses work in combination. L_{node} is directed to ensuring that the node representations are close to their desired values by minimizing the Frobenius norm-based difference. L_{edge} is directed to ensuring the model's output matches the actual presence or absence of edges in the training graphs. The L_{mini-batch} combines both these losses and allows for regularization, providing an error metric that Method 150 seeks to optimize. Through the iterative optimization of this combined loss, the decoder system 116 refines its parameters to achieve better representations of the input graphs, leading to superior performance in graph generation or prediction tasks.

Now referring to the decoder system 116 during test time or in application, the decoder system 116 can be configured to predict or estimate the denoised node representation Z(t) where t∈[0, T] (knowing that Z(0)=X(0)) (using the node decoder) and predict or estimate the adjacency matrix A (using the edge decoder). In some embodiments, the decoder system 116 can be alternatively implemented using alternative or combinational (together) computational models for graph data processing, such as a graph neural network or a graph transformer. For example, a graph neural network or a graph transformer could be trained to receive the adjacency matrix and noisy node representations as inputs to process the graph data. Thus, it should be understood that while the decoder system 116 described herein relates to decoding noisy representations from the encoder system 114, alternative or combinational architectures employing graph neural networks or graph transformers could be employed.

In some embodiments, the decoder system 116 can be further configured to decode a noisy representation from the encoder system 114 to generate class-conditional graphs. In particular, each category of graph (e.g., Erdos-Renyi graphs and stochastic block model graphs) can have unique characteristics and distributions. For example, when analyzing 10 distinct categories of graphs the decoder system 116 can generate a graph for a specific category. In some embodiments, the decoder 116 can be configured to input Yⁱ∈[0, 1]ⁿ^{ᵢ}^{×|C|} to Xⁱ(t) into both decoders (e.g., edge and node), where each row of Yⁱ is a hot-vector whose nonzero index corresponds to the category of the graph Gᵢ. This sampling strategy can be defined as condition sampling. In some embodiments, the rest of the test method (Method 130) is maintained and all the steps are still performed.

The analysis database 120 serves as a repository for storing and managing data used for directed graph generation. In some embodiments, the analysis database 120 includes a training dataset 122, which stores various samples of directed ad potentially undirected graphs that represent known patterns, structures, and topological information. The training dataset 122 can be used by the decoder system 116 to train or update the edge and node models. Additionally, the analysis database 120 can store various formulas, functions, expressions, equations, and propositions used by the analysis system (e.g., by data augmentation system 112, encoder system 114, and decoder system 116). In some embodiments, the training dataset 122 can be updated based on outputs of the edge and node model, or based on third-party data sources. In some embodiments, the analysis database 120 can be a distributed NoSQL database system, optimized for high-velocity data ingestion and horizontal scalability to handle vast and complex graph datasets. In some embodiments, the analysis database 120 can be a specialized graph database, such as Neo4j or OrientDB, which inherently supports graph-like queries and can store, manage, and traverse connected data more efficiently than traditional relational databases. In some embodiments, the analysis database 120 can include multiple data storages or a subset of database, each configured to store distinct types of data used in the directed graph generation process.

Accordingly, the disclosed embodiments of FIG. 1A can be included in a variety of different systems for network design and data analysis, such as automotive systems having control systems for an autonomous or semi-autonomous machine (e.g., an AI driver, an in-vehicle infotainment system, and so on) and/or a perception system (e.g., sensor systems and so on) for an autonomous or semi-autonomous machine, systems implemented using a robot, aerial systems, medical systems, boating systems, smart area monitoring systems, systems for performing deep learning operations, systems for performing simulation operations, systems for generating or presenting virtual reality (VR) content, augmented reality (AR) content, and/or mixed reality (MR) content, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implementing one or more language models—such as one or more large language models (LLMs), systems for hosting real-time streaming applications, systems for performing light transport simulation, systems for performing collaborative content creation for 3D assets, systems implemented at least partially using cloud computing resources, and/or other types of systems. The embodiments described in FIG. 1A can be adapted for specific computational platforms, enhancing algorithmic development for data-intensive tasks across diverse industries. Thus, the disclosed embodiments can integrate into diverse applications enabling refined analytical computation and improved accuracy.

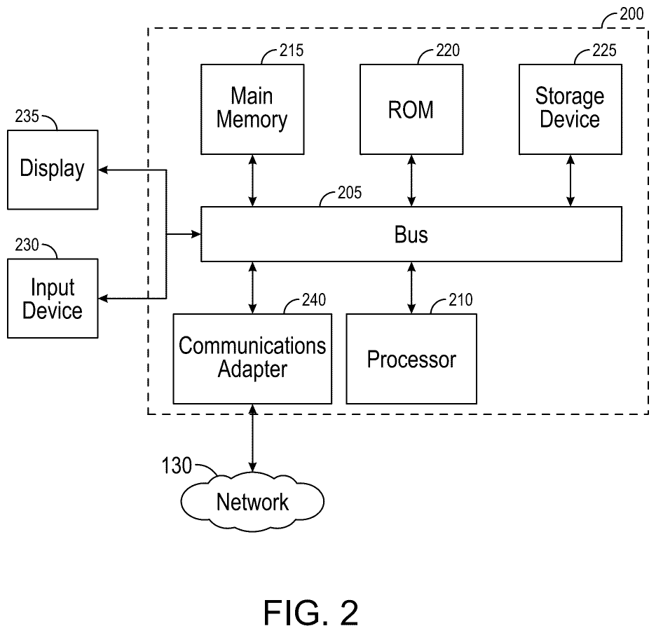

Referring now to FIG. 2, a depiction of a computer system 200 is shown. The computer system 200 can be used, for example, to implement a computing environment 100, analysis system 110, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display or active matrix display, for displaying information to a user. An input device 230, such as a keyboard including alphanumeric and other keys, may be coupled to the bus 205 for communicating information and command selections to the processor 210. In another arrangement, the input device 230 has a touch screen display 235. The input device 230 can include any type of biometric sensor, a cursor control, such as a mouse, a trackball, or cursor direction keys for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with a computing or communications network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, or WAN.

According to various arrangements, the processes that effectuate illustrative arrangements described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, neural network, artificial intelligent model) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may comprise virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 may include cloud computing resources such that a virtual resource may rely on distributed processing across more than one physical processor, distributed memory, etc.

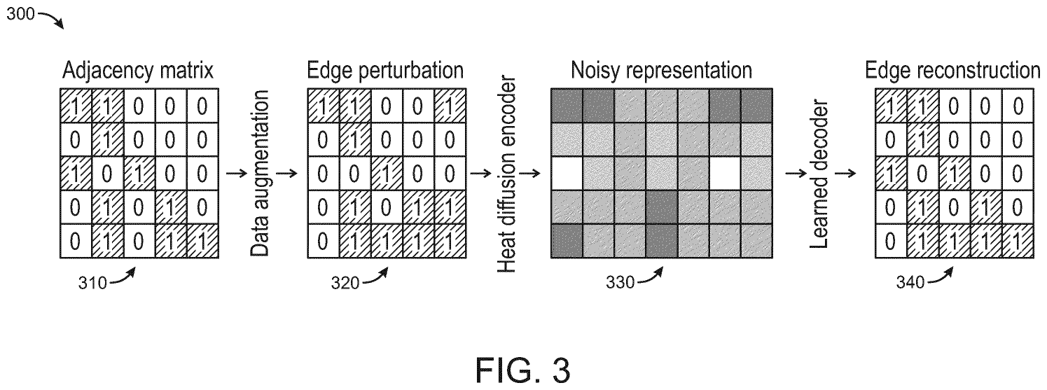

Referring now to FIG. 3, a block diagram depicting an implementation of a graph generation architecture 300, according to one or more embodiments. The graph generation architecture 300 can be implemented by the analysis system 110. For example, the analysis system 110 can receive or generate the adjacency matrix (e.g., first data structure) at step 310. In some embodiments, data augmentation system 112 can in some examples perform edge perturbation at step 320. At step 330, the encoder system 114 can perform heat diffusion to generate a noisy representation. The noisy representation can be taken as input by the decoder system 116, and the decoder system 116 can then perform edge construction at step 340 to generate the adjacency matrix (e.g., the first data structure)

In some embodiments, the graph generation architecture 300 processes the adjacency matrix to in some examples prepare it for edge perturbation by the data augmentation system 112 at step 320. The quality of the adjacency matrix can influence the outcome of the edge perturbation. In some embodiments, the encoder system 114 employs algorithms or mathematical models to perform heat diffusion. This ensures a deterministic and consistent generation of the noisy representation, which aligns with the primary objective of the analysis system 110-to introduce controlled variations without deviating significantly from the original data's structure. This approach produces a noisy representation from a Laplacian matrix, setting the stage for decoding.

With regards to the Laplacian matrix, as described above, the Laplacian matrix can be derived from the adjacency matrix of a graph and is used in the diffusion processes over that graph. The adjacency matrix, denoted as A, is a binary matrix that provides information about the connection status between two nodes. In response to there being a connection, the matrix's respective entry is marked as 1, and if not, it's 0. In some embodiments, the data augmentation system 112 can perform alterations or perturbations to this matrix, which results in what is termed as a perturbed adjacency matrix. Next, the degree matrix, labeled as D, is a diagonal matrix wherein each of its diagonal entries, specifically Dᵢᵢ, denotes the sum of the i-th row (e.g., in-degree of nodes, or in simpler terms, the count of incoming edges to a particular node) of the adjacency matrix A. Then the column stochastic matrix, labeled as S, can be derived by scaling the adjacency matrix A by the inverse of the degree matrix D, ensuring that the sum of each of its columns is 1. In some embodiments, the Laplacian matrix, represented as L, can be formulated by subtracting the identity matrix, I, from S (i.e., the random walk Laplacian). The significance of the Laplacian matrix is the ability of the encoder system 114 to capture the intricate topological structure of the graph, which is important in defining diffusion kernels. These specific kernels provide insights into how information or even heat, for that matter, spreads or diffuses across the graph. In some embodiments, the diffusion dynamic of the encoder system 114 can depict the evolution of the node representation, X(t), over time, which is driven by the Laplacian dynamics. Expression 1, the heat expression

$$\frac{d}{d t} X ( t ) = Δ X ( t ) + Q ( t ) ,$$

describes this diffusion process. In this expression, Δ symbolizes the Laplacian operator, which can either be L or its transpose, L^{T}, and Q(t) stands for the heat source term.

Now referring to the decoder system 116 during test time or in application at step 340. The goal is to ensure accurate edge construction at step 340, resulting in a final graph that closely matches the original with modifications introduced in earlier steps. The decoder system 116 can be configured to predict or estimate the denoised node representation Z(t) where t∈[0,T] (knowing that Z(0)=X(0)) (using the node decoder) and predict or estimate the adjacency matrix A (using the edge decoder). In some embodiments, the decoder system 116 interprets the representation Z(t)—a noise or transformed version of the node representation X(t)—from the encoder system 114. Using the Laplacian dynamics and the expression

$$\frac{d}{d t} X ( t ) = Δ X ( t ) + Q ( t ) ,$$

the decoder system 116 seeks to predict how information has diffused over the graph, using insights derived from the Laplacian matrix L and the adjacency matrix A. This results in a final graph that closely matches the original and also incorporates the modifications introduced at step 320 through the perturbed adjacency matrix, in some examples.

At step 340, edge decoder (i.e., neural network) focuses on interpreting the output from the encoder system 114 to accurately reconstruct or predict the relationships (edges) between nodes in the graph. In contrast, the node decoder (i.e., a different neural network) utilizes the same output to generate or refine the representations (features) of individual nodes within the graph. Both decoders use the encoded information from the encoder system 114 to serve distinct functions: edge construction and node representation, ensuring a complete understanding of the graph's structure and content.

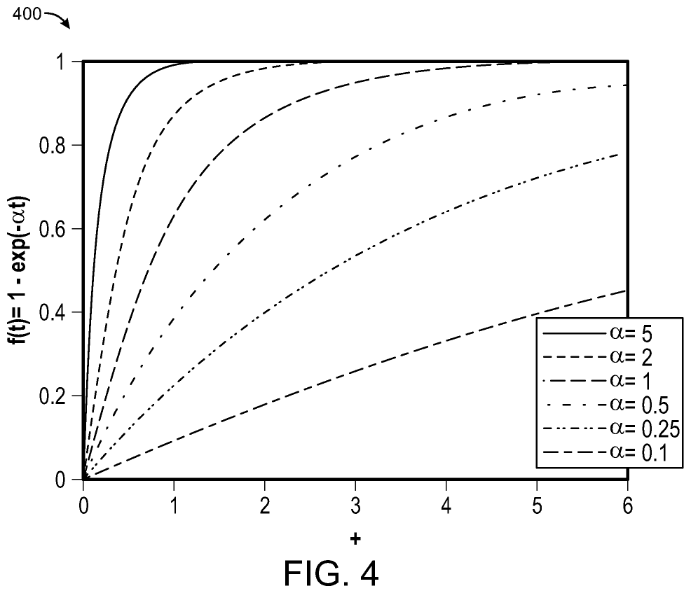

Referring now to FIG. 4, a depiction of an illustrative example of a noise ratio graph 400. The noise ratio graph 400 visually represents the relationships between the noise ratio and the different values of α. The matrix Xⁱ(T) serves as the input to the decoder system 116 (i.e., to the edge and node decoders) to reconstruct Gᵢ, with the objective to have Xⁱ(T)=e^{-αT}Zⁱ(t)+(1−e^{-αT})M to be similar to matrix M. This similarity can depend on both T and α, and Xⁱ(T) tends to M as T or α tend to +∞. For example, setting T=1 and selecting a large enough can be used (e.g., α=2.3 implies 1−e^{-αT}≈0.9, which is indicative that about 90% of the values of X(T) are random). However, the optimal value of both T and α can be determined via cross-validation, depending on the task. As shown, FIG. 4 illustrates the ratio of noise for different values of α. It should also be understood that it is desired for X ⁱ(T) to be similar to M so that sampling a similar matrix at test time is more efficient, but also it is desired for Xⁱ(T) to preserve enough information so that the neural networks (e.g., edge and node) can reconstruct Tⁱ and Aⁱ (i.e., the node and edge information of the graph) from it.

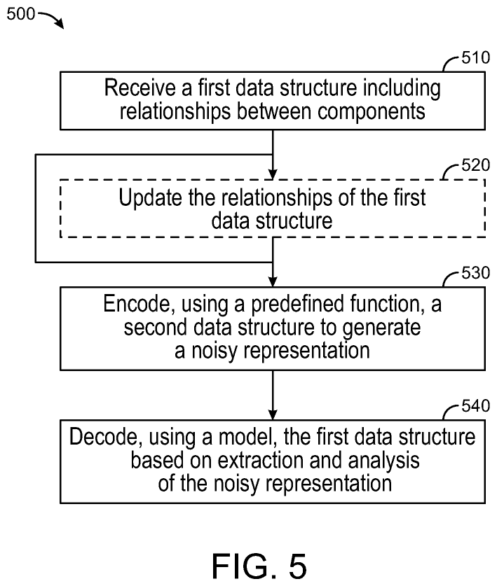

Referring now to FIG. 5, a flowchart for a method 500 for graph generation is shown, according to some embodiments. Analysis system 110 can be configured to perform method 500. Further, any computing device described herein can be configured to perform method 500.

In broad overview of method 500, at block 510, the one or more processing circuits (e.g., analysis system 110 in FIG. 1A) can receive a first data structure including relationship between components. In some examples, at block 520 (shown with dotted lines), the one or more processing circuits can update the relationships of the first data structure. At block 530, the one or more processing circuits can encode, using a predefined function, a second data structure to generate a noisy representation. At block 540, the one or more processing circuits can decode, using a model, the first data structure based on extraction and analysis of the noisy representation. Additional, fewer, or different operations may be performed depending on the particular arrangement. In some embodiments, some, or all operations of method 500 may be performed by one or more processors executing on one or more computing devices, systems, or servers. In various embodiments, each operation may be re-ordered, added, removed, or repeated.

In general, method 500 implements Method 130 described above. It should be understood that the first data structure is an asymmetric node representation matrix, the second data structure is a Laplacian matrix, and the plurality of components are a plurality of nodes. Additionally, the asymmetric node representation matrix is an initial asymmetric node representation matrix prior to receiving the first data structure and is a predicted asymmetric node representation matrix obtained by decoding. Specifically, the goal is to obtain this initial asymmetric node representation matrix from the decoding process. However, it's important to note that the predicted asymmetric node representation, post-decoding, may not be an exact match to the initial matrix (e.g., predicted asymmetric node representation can not be the same due to noise introduced during the encoding process or potential loss of information during data compression).

At block 510, the one or more processing circuits can receive a first data structure (e.g., adjacency matrix) including one or more relationships (e.g., edges) between a plurality of components (e.g., nodes). In some embodiments, the first data structure can be an adjacency matrix of a directed graph, the plurality of components can correspond to a plurality of nodes of the directed graph, and the one or more relationships correspond to edges in the directed graph. Specifically, the adjacency matrix corresponds to a two-dimensional array including a plurality of cells indicating a presence or an absence of a relationship between at least two of the plurality of components.

In some examples, at block 520, the one or more processing circuits can update the one or more relationships of the first data structure based on adding or removing at least one of the one or more relationships of the first data structure. In some embodiments, updating includes performing edge perturbation as described in detail above with reference to data augmentation system 112.

At block 530, the one or more processing circuits can encode, using a predefined function, a second data structure (e.g., Laplacian matrix) determined based on the first data structure to generate a noisy representation of the second data structure. In some embodiments, the predefined function is a deterministic noising process, rather than a trained model. The deterministic noising process can be a deterministic graph diffusion process corresponding to a propagation of node features of the plurality of nodes over a network topology based on the Laplacian matrix and the asymmetric initial node representation matrix.

In more detail, at block 530, the one or more processing circuits initiate the encoding of the second data structure, specifically the Laplacian matrix. This encoding utilizes a predefined function designed to produce a noisy representation of the Laplacian matrix. What differentiates this from some other processes is that the predefined function used is not reliant on a trained model but rather operates through a deterministic noising mechanism. This deterministic mechanism, known as a deterministic graph diffusion process, functions by propagating the node features across the network. The direction and flow of this propagation are influenced by the Laplacian matrix in conjunction with the asymmetric initial node representation matrix. Additional information regarding encoding is described in detail above with reference to encoder system 114.

At block 540, the one or more processing circuits can decode, using one or more models, the first data structure based on feature extraction and pattern analysis of the noisy representation. In other words, the noisy representation is decoded to produce the first data structure (i.e., the adjacency matrix). Specifically, the first data structure is the adjacency matrix captures which nodes are connected to each other. For example, it can be understood that the noisy representation is a distorted or corrupted version of the adjacency matrix. The decoding process aims to recover the original, clean adjacency matrix from the noisy version. Additionally, the decoding process can be understood to analyze or extract information from the noisy representation to decode a first data structure (i.e., the adjacency matrix). Nonetheless, the first data structure can be decoded from the noisy representation (i.e., extraction process from an encoded format). Thus, decoding signifies that the original information (i.e., adjacency matrix) is obfuscated or altered in the noisy representation, requiring a decoding step to retrieve it. Specifically, decoding the first data structure illuminates the complexity of the task, indicating that the information is not directly accessible but needs decoding to unveil the adjacency matrix from the noisy representation provided by the encoder.

Thus, the decoding process uses the one or more models including using a first model and a second model for the feature extraction and the pattern analysis. In some embodiments, the first model corresponds to the feature extraction using a decoding of the plurality of components based on one or more inherent features or the one or more relationships of the plurality of components in the noisy representation. Specifically, feature extraction can be performed by the edge decoder of decoder system 116 described in greater detail above. In some embodiments, the second model corresponds to the pattern analysis using a decoding of edges based on graph adjacency patterns. Specifically, the pattern analysis can be performed by the node decoder of decoder system 116 described in greater detail above. In some embodiments, the first data structure.

In more detail, at block 540, the one or more processing circuits, executing the decoding process, utilize multiple models, providing a layered approach to decode the first data structure. In some embodiments, feature extraction involves identifying specific information from the noisy representation. The edge decoder (ψ) neural network can be trained to discern inherent features or underlying relationships among the components present in the noisy representation. Specifically, the edge decoder neural network can extract the features. Additionally, the node decoder (φ) neural network can be trained to identify graph adjacency patterns. Specifically, edges can be decoded in the noisy representation, providing insights into their structural and relational patterns. Additional information regarding decoding is described in detail above with reference to decoder system 116. Accordingly, the models work simultaneously to extract inherent features and identify graph adjacency patterns, enabling the generation of both edges and nodes in a unified step (one-shot).

In some embodiments, prior to method 500 the decoders (e.g., edge and node) can be trained or updated (i.e., according to Method 150). In general, training can include receiving a plurality of training data structures, each training data structure includes an adjacency matrix and a Laplacian matrix. For each training data structure, the adjacency matrix is modified to create a modified adjacency matrix with a disturbance. This disturbance is based on a predetermined factor to introduce noise into the adjacency matrix of each training data structure. From this, one or more component representations (i.e., node representations) are extracted based on both the original adjacency matrix and the modified adjacency matrix. These component representations are then updated to create updated component representations through exponentiation operations that correspond to the modified adjacency matrix and predefined hyperparameters. Using the updated component representations, a node decoder is trained. Concurrently, an edge decoder is trained based on the one or more component representations. In some embodiments, the training data structure further includes adding permutation invariance to each training data structure.

Referring to the training in greater detail, modifying the adjacency matrix to create the modified adjacency matrix with a disturbance includes generating a perturbation matrix C as per lines 8-10 of Method 150 where each entry follows a Bernoulli distribution with parameter p. This results in the modified adjacency matrix Ãⁱ being the bitwise exclusive OR between Aⁱ⊕C. Alternatively, in some embodiments, the adjacency matrix can be permuted (i.e., modified the adjacency matrix to create the modified adjacency matrix) to promote invariance through the generation of a random permutation matrix P as outlined in lines 3-5 of Method 150. Specifically, modifying the adjacency matrix to create the modified adjacency matrix of each training data structure with a disturbance can be based on a random permutation to promote invariance in the adjacency matrix of each training data structure. In some embodiments, if not data augmentation matrix is applied, the modified Laplacian matrix \tilde{Δ}ⁱ will default to the original Laplacian matrix Δⁱ as indicated in lines 11-12 of Method 150.

Additionally, extracting the one or more component representations based on the adjacency matrix and the modified adjacency matrix of each training data structure includes a determined upper submatrix N as outline in line 14 of Method 150 with l₁-normalized columns. The matrix B can then be defined as per line 15 using the exponentiation of the modified Laplacian matrix \tilde{Δ}ⁱ scaled by a factor T. Furthermore, updating the one or more component representations to create updated component representations based on exponentiation operations corresponding to the modified adjacency matrix and predefined hyperparameters includes calculating Xⁱ(T) as described in line 16 of Method 150 as a weighted sum of B multiplied by N and a matrix M, with weights determined by the exponentiation of −αT. In some embodiments, the matrix E can be defined as the exponential of the product of t and the Laplacian matrix Δⁱ, described in line 17. In some examples, a rank-s approximation of E can be used, which is obtained via truncated Singular Value Decomposition (SVD). In some embodiments, the matrix Tⁱ can be derived or determine using an exponential function applied to the Laplacian matrix, and the mini-batch loss is updated by summing the edge loss and a weighted node loss determine by the regulation parameter λ, described in lines 18-19.

Additionally, the mini-batch loss can be optimized by adjusting the model parameters to minimize the loss, as shown in line 21. In some embodiments, training a node decoder based on the updated component representations includes utilizing the node representations Xⁱ(T) from line 16 and applying a non-linear transformation a non-linear transformation to predict the unnoisy node attributes at time t=1 (e.g., using a linear projection to predict the original or modified node attributes). In some embodiments, training the edge decoder based on the one or more component representations includes using the matrix Tⁱ from line 18, and processing it through a series of transformations to predict the original adjacency matrix values. Thus, the optimization procedure in line 21 ensures that the decoders are effectively trained by iteratively refining the weights to reduce the computed mini-batch loss. Additional information regarding the training is described above with reference to Method 150.

Accordingly, method 500 and the systems described herein provide various improvements over existing implementations and systems. Specifically, method 500 is directed to improving the accuracy and efficiency of generating directed graphs by using global topological information. It does so by analyzing and learning from the structure and distribution of a provided training dataset. Unlike the conventional auto-regressive graph generation that incrementally builds up a graph, method 500 and the systems described herein use on one-shot generation, which creates an entire graph in a single action. This approach is advantageous because it avoids the computationally taxing multiple steps and potential accumulation of errors seen in auto-regressive techniques. However, many existing one-shot generation methods primarily cater to undirected graphs.

The systems and method 500 described above rectify the limitations of current techniques. Specifically, they integrate models using singular values and singular vectors instead of solely depending on the eigenvalues and eigenvectors which may produce complex number representations in non-symmetric matrices. This allows for more consistent and efficient generation of directed graphs. As a consequence, this approach finds wider applicability in varied fields like causality modeling and Markov chains.

Method 500 and the systems described herein utilize a unique denoising autoencoder approach, which doesn't derive the noising process from neural networks. Instead, it employs closed-form expressions based on a heat expression. This expression translates a graph's global topological information into node features, resulting in the generation of directed graphs that align closely with the training dataset or provide accurate test and/or in application predictions. The approach combines Laplacian dynamics, diffusion processes, and heat expressions, offering a refined method for handling digraphs. This strategy is scalable, efficient, and addresses previously noted limitations. With a focus on Laplacian matrices, method 500 and the systems described herein can replicate the training graph structures effectively and product accurate testing and in application predictions. For example, in situations like protein synthesis, the model can be trained to generate new proteins mirroring the graph distribution from its training phase. While traditional models have been trained on undirected graphs, method 500 and the systems described herein are directed towards producing directed graphs. This one-shot generative model approach can create all nodes and their connecting edges in one go.

Additionally, traditional systems for undirected graphs generally use a symmetric adjacency matrix, leading to a symmetric Laplacian matrix. While this matrix offers important data about the graph through its eigenvectors and eigenvalues, its application is restricted to undirected graphs. This presents challenges when the need arises for directed graphs, especially in scenarios that demand causality. To address this, method 500 and the systems described herein shift from using eigenvalues and eigenvectors to singular values and singular vectors, which are real values. This shift proves important in applications that require directed graph structures, such as in Markov chains or causality mapping.

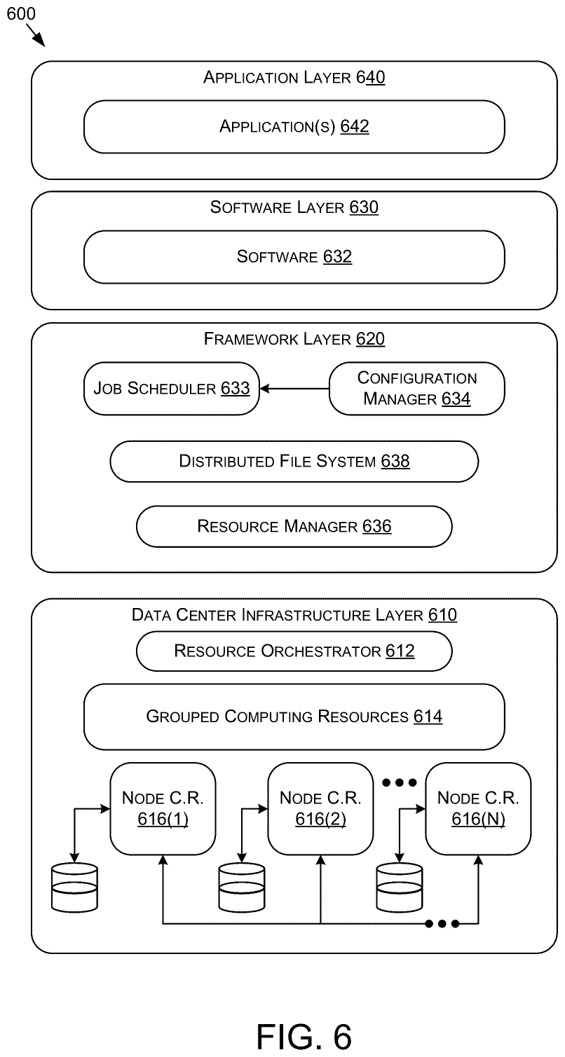

FIG. 6 illustrates an example data center 600 that may be used in at least one embodiments of the present disclosure, such as to implement the analysis system 110 or the analysis database 120 in one or more examples of the data center 600. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to perform training of the machine learning models of analysis system 110.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models (e.g., train the machine learning models of analysis system 110) or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program including a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, includes multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system including multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may include one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities can be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processing circuits to:
receive a first data structure comprising one or more relationships between a plurality of components;
encode, using a predefined function, a second data structure determined based on the first data structure to generate a noisy representation of the second data structure; and
decode, using one or more models, the noisy representation based on feature extraction and pattern analysis of the noisy representation to obtain the first data structure.

2. The system of claim 1, wherein the one or more processing circuits are further to:
update the one or more relationships of the first data structure based on adding or removing at least one of the one or more relationships of the first data structure.

3. The system of claim 2, wherein:
the first data structure is an adjacency matrix of a directed graph, the plurality of components corresponding to a plurality of nodes of the directed graph, and the one or more relationships correspond to edges in the directed graph.

4. The system of claim 3, wherein:
the adjacency matrix corresponds to a two-dimensional array comprising a plurality of cells indicating a presence or an absence of a relationship between at least two of the plurality of components.

5. The system of claim 1, wherein:
the decoding using the one or more models comprises using a first model and a second model for the feature extraction and the pattern analysis.

6. The system of claim 5, wherein:
the first model corresponds to the feature extraction using a decoding of the plurality of components based on one or more inherent features or the one or more relationships of the plurality of components in the noisy representation; and
the second model corresponds to the pattern analysis using a decoding of edges based on graph adjacency patterns.

7. The system of claim 1, wherein the system is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing large language models (LLMs);
a system for hosting one or more real-time streaming applications;
a system for performing light transport simulation;
a system for performing collaborative content creation for 3D assets; or
a system implemented at least partially using cloud computing resources.

8. A method, comprising:
receiving a first data structure comprising one or more relationships between a plurality of components;
encoding, using a predefined function, a second data structure determined based on the first data structure to generate a noisy representation of the second data structure; and
decoding, using one or more models, the noisy representation based on feature extraction and pattern analysis of the noisy representation to obtain the first data structure.

9. The method of claim 8, further comprising:
updating the one or more relationships of the first data structure based on adding or removing at least one of the one or more relationships of the first data structure.

10. The method of claim 9, wherein:
the first data structure is an adjacency matrix of a directed graph, the plurality of components corresponding to a plurality of nodes of the directed graph, and the one or more relationships correspond to edges in the directed graph.

11. The method of claim 10, wherein:
the adjacency matrix corresponds to a two-dimensional array comprising a plurality of cells indicating a presence or an absence of a relationship between at least two of the plurality of components.

12. The method of claim 8, wherein:
the decoding using the one or more models comprise using a first model and a second model for the feature extraction and the pattern analysis;
the first model corresponds to the feature extraction using a decoding of the plurality of components based on one or more inherent features or the one or more relationships of the plurality of components in the noisy representation; and
the second model corresponds to the pattern analysis using a decoding of edges based on graph adjacency patterns.

13. The method of claim 8, wherein:
the first data structure is an asymmetric node representation matrix;
the second data structure is a Laplacian matrix; and
the plurality of components are a plurality of nodes.

14. The method of claim 13, wherein:
the predefined function is a deterministic graph diffusion process corresponding to a propagation of node features of the plurality of nodes over a network topology based on the Laplacian matrix and the asymmetric initial node representation matrix.

15. The method of claim 8, wherein:
the asymmetric node representation matrix is an initial asymmetric node representation matrix prior to receiving the first data structure and is a predicted asymmetric node representation matrix obtained by decoding.

16. A method, comprising:
receiving a plurality of training data structures, wherein at least one training data structure of the plurality of training data structures comprises an adjacency matrix and a Laplacian matrix;
for the at least one training data structure of the plurality of training data structures:
extracting one or more component representations based on the adjacency matrix and a modified adjacency matrix of the at least one training data structure;
updating the one or more component representations to create updated component representations based on exponentiation operations corresponding to the modified adjacency matrix and predefined hyperparameters;
updating a node decoder based on the updated component representations; and
updating an edge decoder based on the one or more component representations.

17. The method of claim 16, further comprising:
adding permutation invariance to the at least one training data structure.

18. The method of claim 16, wherein:
updating the node decoder and the edge decoder corresponds to updating a first neural network and updating a second neural network, and wherein the first neural network is updated for feature extraction based on one or more inherent features or the one or more relationships of the one or more of components representations, and wherein the second neural network is updated for pattern analysis using a decoding of edges based on graph adjacency patterns of the updated component representations.

19. The method of claim 18, further comprising, for the at least one training data structure of the plurality of training data structures, prior to the extracting:
modifying the adjacency matrix to create the modified adjacency matrix of the at least one training data structure with a disturbance based on a predetermined factor to introduce noisy in the adjacency matrix of each training data structure.

20. The method of claim 18, further comprising, for the at least one training data structure of the plurality of training data structures, prior to the extracting:
modifying the adjacency matrix to create the modified adjacency matrix of the at least one training data structure with a disturbance based a random permutation to promote invariance in the adjacency matrix of each training data structure.
